(19) United States
(12) Patent Application Publication
(10) Pub. No.: US 2022/0309433 A1
(43) Pub. Date: Sep. 29, 2022

(54) MANAGEMENT SUPPORT APPARATUS, MANAGEMENT SUPPORT METHOD, AND COMPUTER READABLE MEDIUM

(71) Applicant: Mitsubishi Electric Corporation, Tokyo (JP)

(72) Inventor: Hiroyuki YAMADA, Tokyo (JP)

(73) Assignee: Mitsubishi Electric Corporation, Tokyo (JP)

(21) Appl. No.: 17/840,315

(22) Filed: Jun. 14, 2022

Related U.S. Application Data
(63) Continuation of application No. PCT/JP2020/004534, filed on Feb. 6, 2020.

(51) Int. Cl. G06Q 10/06

(52) U.S. Cl. CPC G06Q 10/06315

(57) ABSTRACT

A probability-distribution derivation unit (113) derives based on a measurement result obtained by measuring a deterioration degree resulted from usage of an item which deteriorates with the usage, in a usage environment which uses the item which deteriorates with the usage, a probability distribution of a replacement quantity which is a quantity of the item required to be replaced at a replacement timing of the item. Further, a replacement-quantity calculation unit (114) calculates a replacement quantity with which a lower probability of the probability distribution of the replacement quantity which is the quantity of items required to be replaced at the replacement timing of the item is equal to or larger than a criterion value.

### CROSS REFERENCE TO RELATED APPLICATION

This application is a Continuation of PCT International Application No. PCT/JP2020/004534, filed on Feb. 6, 2020, which is hereby expressly incorporated by reference into the present application.

### TECHNICAL FIELD

The present disclosure relates to a management support apparatus, a management support method, and a management support program.

### BACKGROUND ART

Conventionally, the inventory quantity of items such as a device used in a system and parts which constitute the device has been managed relying on experience of a person. Then, in such a method of managing the inventory quantity based on the experience of the person, it is difficult to secure an experienced person who can manage the inventory quantity properly, and labor required for estimating the inventory quantity is a lot.

However, in the method of estimating the inventory quantity based on the experience of the person, there is a problem that estimation accuracy is low and management is performed less properly. Then, a technique regarding the management of the inventory quantity is proposed (for example, see Patent Literature 1).

### CITATION LIST

### Patent Literature

Patent Literature 1: JP2018-142256A

### SUMMARY OF INVENTION

### Technical Problem

A technique of Patent Literature 1 predicts the number of malfunctions of items which are in use, using a cumulative malfunction rate of the items which are in use. Then, the necessary minimum inventory quantity of replacing items which replace the items which are in use is estimated based on the predicted number of malfunctions.

However, since the cumulative malfunction rate is an expected value of a probability distribution of the number of malfunctions, probabilistic variability in the number of malfunctions is ignored.

Thus, in the technique of Patent Literature 1, there is a possibility that an error has occurred in prediction of the number of malfunctions of the items which are in use, due to the probabilistic variability and the estimation accuracy of the inventory quantity is deteriorated.

Thus, the technique of Patent Literature 1 has a problem that the necessary minimum inventory quantity of replacing items cannot be properly estimated, which may result in an inventory shortage or excess inventory.

One of the main objects of the present disclosure is to solve the above-described problem, and the main object is to properly estimate the necessary minimum inventory quantity of replacing items and consequently, prevent an inventory shortage and excess inventory.

### Solution to Problem

A management support apparatus according to the present disclosure includes:

a probability-distribution derivation unit to derive based on a measurement result obtained by measuring a deterioration degree resulted from usage of an item in a usage environment which uses the item which deteriorates with the usage, a probability distribution of a replacement quantity which is a quantity of the item required to be replaced at a replacement timing of the item; and

a replacement-quantity calculation unit to calculate a replacement quantity with which a lower probability of the probability distribution of the replacement quantity is equal to or larger than a criterion value.

### Advantageous Effects of Invention

According to the present disclosure, it is possible to properly estimate the necessary minimum inventory quantity of replacing items, and consequently, prevent an inventory shortage and excess inventory.

### BRIEF DESCRIPTION OF DRAWINGS

FIG. 1 is a configuration diagram of a management system according to a first embodiment.

FIG. 2 is a diagram illustrating a hardware configuration example of a management support apparatus according to the first embodiment.

FIG. 3 is a diagram illustrating a functional configuration example of the management support apparatus according to the first embodiment.

FIG. 4 is a flowchart illustrating an operation example of the management support apparatus according to the first embodiment.

FIG. 5 is a flowchart illustrating an example of calculation processes of replacement deterioration threshold values and deterioration-threshold-value probabilities by the management support apparatus according to the first embodiment.

FIG. 6 is a flowchart illustrating an example of a derivation process of a probability distribution of a replacement quantity by the management support apparatus according to the first embodiment.

FIG. 7 is a flowchart illustrating an example of a calculation process of the replacement quantity which satisfies a required reliability degree according to the first embodiment.

FIG. 8 is a diagram illustrating a functional configuration example of a management support apparatus according to a second embodiment.

FIG. 9 is a flowchart illustrating an operation example of the management support apparatus according to the second embodiment.

FIG. 10 is a flowchart illustrating an operation example of a management support apparatus according to a third embodiment.

FIG. 11 is a diagram illustrating a functional configuration example of a management support apparatus according to a fourth embodiment.

FIG. 12 is a flowchart illustrating an operation example of the management support apparatus according to the fourth embodiment.

FIG. 13 is a configuration diagram of a central management system according to a fifth embodiment.

FIG. 14 is a diagram illustrating a functional configuration example of a management support apparatus according to the fifth embodiment.

FIG. 15 is a flowchart illustrating an operation example of the management support apparatus according to the fifth embodiment.

FIG. 16 is a flowchart illustrating an example of a derivation process of a probability distribution of a replacement quantity by the management support apparatus according to the fifth embodiment.

FIG. 17 is a diagram illustrating a configuration in which functions of the management support apparatus are realized by hardware, according to the first embodiment.

### DESCRIPTION OF EMBODIMENTS

Hereinafter, embodiments will be described with reference to the drawings. In the following description of the embodiments and the drawings, elements assigned the same reference numerals indicate the same elements or corresponding elements.

Note that, in the following embodiments, descriptions will be given, using parts attached to devices as examples of items which deteriorate with usage.

Further, descriptions will be given, using a next maintenance date and a maintenance date after the next as examples of a replacement timing and a succeeding replacement timing, respectively.

### First Embodiment

### ***Description of Configuration***

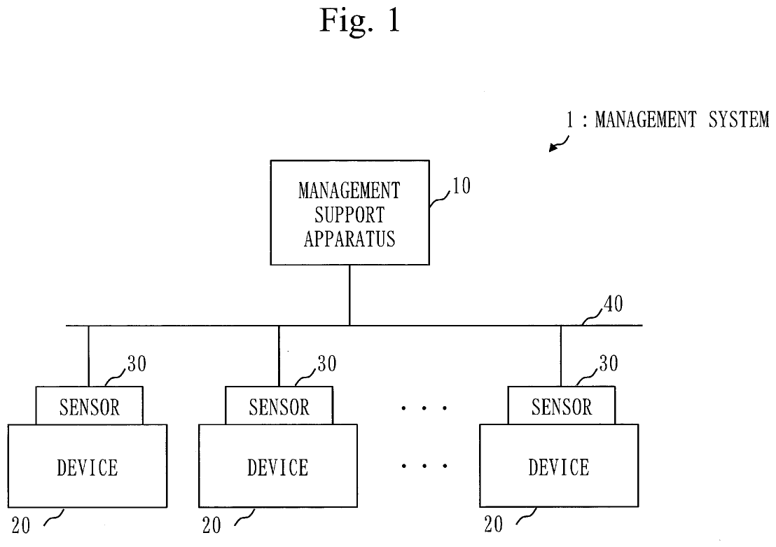

FIG. 1 illustrates a configuration diagram of a management system 1 according to a first embodiment.

The management system 1 includes a management support apparatus 10, devices 20, sensors 30, and a network 40.

The management support apparatus 10 acquires pieces of measurement information regarding deterioration degrees of parts, and calculates the necessary minimum inventory quantity of replacing parts which replace the parts which are in use.

Note that, an operation procedure of the management support apparatus 10 is equivalent to a management support method. Further, a program which realizes operation of the management support apparatus 10 is equivalent to a management support program.

The devices 20 use the parts which deteriorate with usage. The devices 20 are, as specific examples, devices used in social infrastructures such as railroad cars, a power plant, and an elevator. Also, the parts are, as a specific example, brake shoes.

Note that, if there are a plurality of devices 20, the management support apparatus 10 calculates the necessary minimum inventory quantity of replacing parts corresponding to the parts of the same type and the same form which are used commonly in the plurality of devices 20.

The sensors 30 are sensors or measurement tools which measure the deterioration degrees of the parts, attached to the devices 20. Further, the sensors 30 transmit pieces of measurement information regarding the acquired deterioration degrees of the parts of the devices 20 to the management support apparatus 10 via the network 40. The sensors 30 are, as specific examples, abrasion sensors, oil deterioration sensors, or the like.

The network 40 is a wired or wireless communication path for transmitting and receiving data. The network 40 is, as a specific example, a communication path conforming to a communication standard such as Ethernet (registered trademark) or Wi-Fi (registered trademark), or a communication path dedicated to the devices. Further, the network 40 may be a communication network such as an intranet or the Internet.

Note that, in FIG. 1, the quantity of devices 20 and the quantity of sensors 30 are assumed to be the same, but not limited to being the same, the device 20 may use a plurality of parts, and the sensor may be attached to each of the plurality of parts.

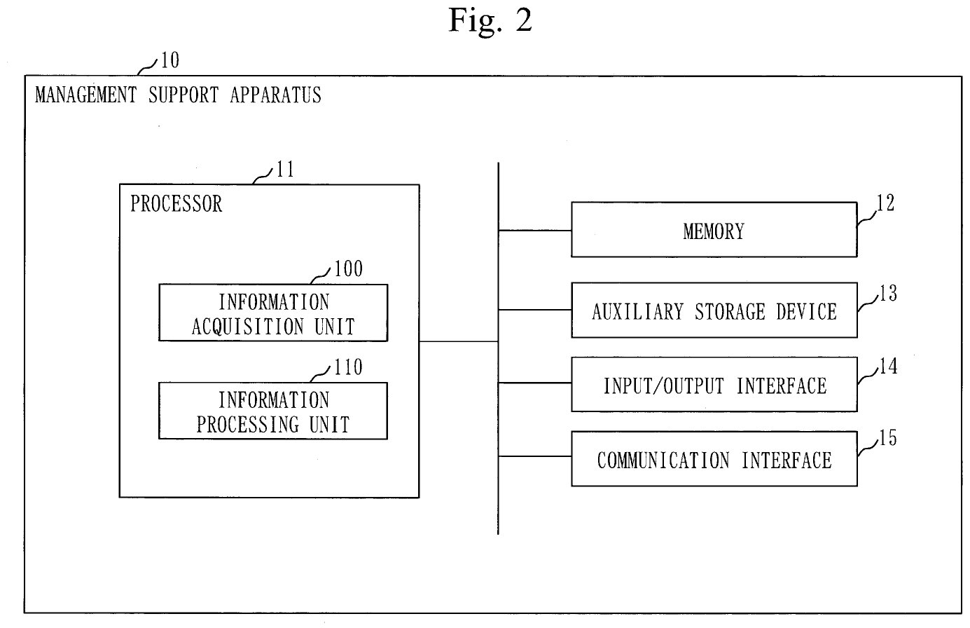

FIG. 2 illustrates a hardware configuration example of the management support apparatus 10 according to the first embodiment.

The management support apparatus 10 is a computer. The management support apparatus 10 includes a processor 11, a memory 12, an auxiliary storage device 13, an input/output interface 14, and a communication interface 15 as pieces of hardware, which are connected to each other via a signal line.

The processor 11 is an IC (Integrated Circuit) which performs processing. The processor 11 is, as a specific example, a CPU (Central Processing Unit), a DSP (Digital Signal Processor), or the like.

The memory 12 is a storage device which temporarily stores data. The memory 12 is, as a specific example, a RAM (Random Access Memory).

The auxiliary storage device 13 is a storage device which stores data in a non-volatile manner. The auxiliary storage device 13 is, as a specific example, a hard disk.

Further, the auxiliary storage device 13 may also be a portable recording medium such as an SSD (registered trademark, Solid State Drive), an SD (registered trademark, Secure Digital) memory card, CF (registered trademark, CompactFlash), NAND flash, a flexible disk, an optical disc, a compact disc, a Blu-ray (registered trademark) disc, or a DVD (registered trademark, Digital Versatile Disk).

The auxiliary storage device 13 stores programs which realize functions of an information acquisition unit 100 and an information processing unit 110 which will be described later. Further, the auxiliary storage device 13 also stores a program which realizes a function of executing deterioration prediction which will be described later.

The programs stored in the auxiliary storage device 13 which realize the function of the information acquisition unit 100, the function of the information processing unit 110, and the function of executing the deterioration prediction are loaded by the memory 12. Further, the programs are read and executed by the processor 11.

Further, the auxiliary storage device 13 also stores an OS (Operating System). Then, at least a part of the OS is executed by the processor 11.

While executing at least the part of the OS, the processor 11 executes the programs which realize the functions of the information acquisition unit 100 and the information processing unit 110.

By executing the OS by the processor 11, task management, memory management, file management, communication control, and the like are performed.

Further, at least one of information, data, a signal value, and a variable value that indicate results of processes of the information acquisition unit 100 and the information processing unit 110 is stored in at least one of the processor 11, the memory 12, and a register and a cash memory in the auxiliary storage device 13.

Further, the programs which realize the functions of the information acquisition unit 100 and the information processing unit 110 may be stored in the portable recording medium such as the hard disk, the SSD (registered trademark), the SD (registered trademark) memory card, the CF (registered trademark), the NAND flash, the flexible disk, the optical disc, the compact disc, the Blu-ray (registered trademark) disc, or the DVD (registered trademark).

Then, the portable recording medium storing the programs which realize the functions of the information acquisition unit 100 and the information processing unit 110 may be distributed.

The input/output interface 14 is an electronic circuit which executes an input/output process of information. The input/output interface 14 receives, as a specific example, information input from a keyboard. Further, the input/output interface 14 transmits the information to a display device.

The communication interface 15 is an electronic circuit which executes a process of communicating information with a connection destination via the signal line. The communication interface 15 is, as a specific example, a communication chip for Ethernet (registered trademark) or an NIC (Network Interface Card).

Note that, “unit” of the information acquisition unit 100 and the information processing unit 110 may be read as “circuit”, “step”, “procedure”, or “process”.

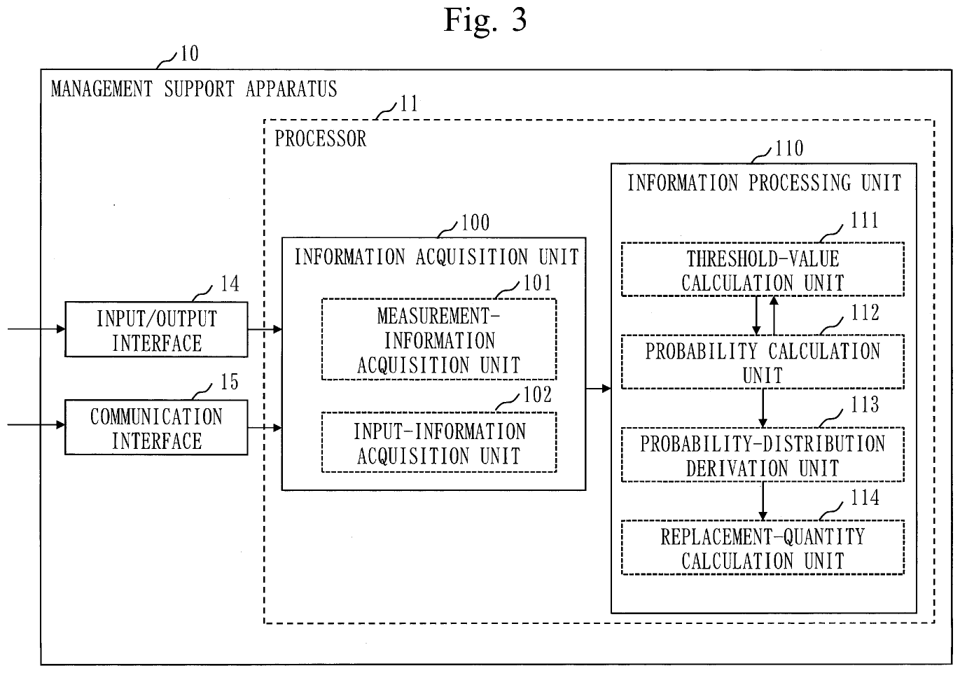

FIG. 3 illustrates a functional configuration diagram of the management support apparatus 10 according to the first embodiment.

The management support apparatus 10 includes the information acquisition unit 100 and the information processing unit 110. Further, the information acquisition unit 100 includes a measurement-information acquisition unit 101 and an input-information acquisition unit 102. Further, the information processing unit 110 includes a threshold-value calculation unit 111, a probability calculation unit 112, a probability-distribution derivation unit 113, and a replacement-quantity calculation unit 114.

The information acquisition unit 100 acquires information to be used for processing by the information processing unit 110.

The measurement-information acquisition unit 101 acquires via the communication interface 15, the pieces of measurement information regarding the deterioration degrees of the parts used in the devices 20, which have been measured by the sensors 30.

The input-information acquisition unit 102 acquires via the input/output interface 14, pieces of input information regarding calculation of a replacement quantity which is the quantity of parts required to be replaced on a next maintenance date. Further, the input-information acquisition unit 102 may acquire the pieces of input information regarding the calculation of the replacement quantity, which have been stored in the auxiliary storage device 13.

The information processing unit 110 calculates the replacement quantity based on the pieces of measurement information regarding the deterioration degrees of the parts acquired by the information acquisition unit 100 and the pieces of input information regarding the calculation of the replacement quantity acquired by the input-information acquisition unit 102.

The threshold-value calculation unit 111 performs the deterioration prediction, using the deterioration degrees of the parts on the next maintenance date, and derives succeeding-deterioration-degree probability distributions which are probability distributions of the deterioration degrees of the parts on a maintenance date after the next. Further, the threshold-value calculation unit 111 calculates based on the succeeding-deterioration-degree probability distributions, replacement deterioration threshold values which are replacement determination criteria for determining whether or not the parts are required to be replaced on the next maintenance date.

Note that, the deterioration prediction according to the first embodiment indicates a process of predicting the probability distributions of the deterioration degrees at an arbitrary time point in the future, based on the deterioration degrees of the parts at some time point.

The probability calculation unit 112 performs the deterioration prediction, using the measurement information on the deterioration degree of each of the plurality of parts of the devices 20, which has been acquired by the measurement-information acquisition unit 101, and derives deterioration-degree probability distributions which are probability distributions of the deterioration degrees of the parts on the next maintenance date. Further, the probability calculation unit 112 calculates deterioration-threshold-value probabilities based on the derived deterioration-degree probability distributions.

The deterioration-threshold-value probability is a probability that the deterioration degree of the part on the next maintenance date is equal to or larger than the replacement deterioration threshold value.

The probability-distribution derivation unit 113 derives a probability distribution of the replacement quantity, using the deterioration-threshold-value probabilities calculated by the probability calculation unit 112 as measurement results (hereinafter, referred to as the measurement results) obtained by measuring the deterioration degrees resulted from usage of the parts in a usage environment where the parts are used.

The replacement-quantity calculation unit 114 calculates a replacement quantity with which a lower probability of the probability distribution of the replacement quantity derived by the probability-distribution derivation unit 113 is equal to or larger than a criterion value.

Then, the replacement-quantity calculation unit 114 stores in the auxiliary storage device 13, the calculated replacement quantity as the necessary minimum inventory quantity of replacing parts. Further, not limited to the above descriptions, the replacement-quantity calculation unit 114 may output the calculated replacement quantity to the display device or the like via the input/output interface 14. Alternatively, the replacement-quantity calculation unit 114 may transmit the calculated replacement quantity to a connection destination via the communication interface 15.

Note that, as the criterion value to be used for a calculation of the replacement quantity, a required reliability degree which is one of the pieces of input information acquired by the input-information acquisition unit 102 is used.

The required reliability degree is an index indicating reliability of the management system 1 which manages the inventory quantity of replacing parts. More specifically, the required reliability degree indicates a probability that an inventory shortage occurs in the management system 1.

That is, by setting the required reliability degree, a manager of the management system 1 can properly estimate the necessary minimum inventory quantity of replacing parts which assures that the inventory shortage does not occur with a certain probability.

As a specific example, if the replacement-quantity calculation unit 114 calculates the replacement quantity which satisfies the required reliability degree which is 90%, the inventory shortage is assured not to occur with a 90% probability if a calculated replacement quantity of replacing parts are prepared by the maintenance date.

***Description of Operation***

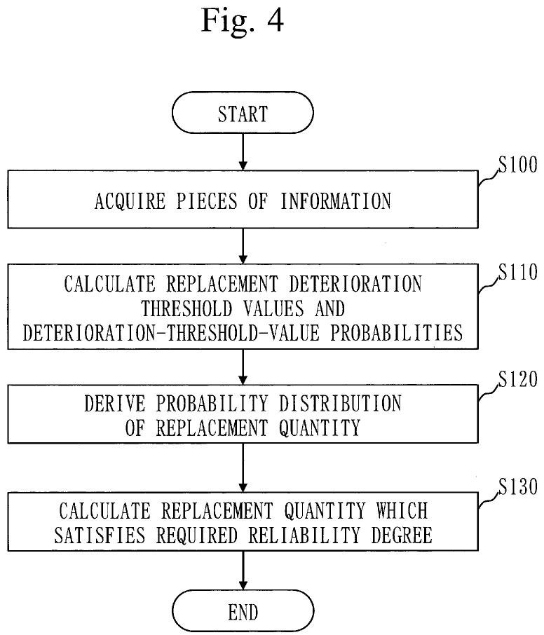

Next, with reference to a flowchart of FIG. 4, an operation example of the management support apparatus 10 according to the first embodiment will be described.

Note that, in the first embodiment, descriptions will be given, using an example in which the maintenance date when part replacement is performed is on a periodic basis such as a weekly basis or a monthly basis.

First, in step S100, the measurement-information acquisition unit 101 acquires the measured deterioration degrees and a measurement date of the deterioration degrees as the pieces of measurement information regarding the deterioration degrees of the parts of the devices 20.

Further, the input-information acquisition unit 102 acquires as the pieces of input information regarding the calculation of the replacement quantity, the quantity of devices using the parts, the next maintenance date, the maintenance date after the next, threshold values (hereinafter, referred to as replacement-limit threshold values) of the deterioration degrees indicating limits regarding the replacement, criterion values (hereinafter, referred to as criterion values for upper probabilities) for upper probabilities of the replacement-limit threshold values, and the required reliability degree.

The replacement-limit threshold value is a limit value on the deterioration degree at which the part can be used without replacement. If the deterioration degree of the part exceeds the replacement-limit threshold value, the part may malfunction, and the part needs to be replaced immediately without waiting for the next maintenance date.

The criterion value for the upper probability is a probability used as a criterion compared with the upper probability that the deterioration degree is equal to or larger than the limit-deterioration threshold value in the probability distribution of the deterioration degree.

Next, in step S110, the threshold-value calculation unit 111 calculates the replacement deterioration threshold values. Further, the probability calculation unit 112 calculates the deterioration-threshold-value probabilities, using the replacement deterioration threshold values calculated by the threshold-value calculation unit 111. Details of calculation processes of the replacement deterioration threshold values and the deterioration-threshold-value probabilities will be described later.

Next, in step S120, the probability-distribution derivation unit 113 derives the probability distribution of the replacement quantity, using the deterioration-threshold-value probabilities calculated by the probability calculation unit 112. Details of a derivation process of the probability distribution of the replacement quantity will be described later.

Then, in step S130, the replacement-quantity calculation unit 114 calculates the replacement quantity which satisfies the required reliability degree, using the probability distribution of the replacement quantity derived by the probability-distribution derivation unit 113. Then, the replacement-quantity calculation unit 114 outputs the calculated replacement quantity as the necessary minimum inventory quantity of replacing parts. Details of a calculation process of the replacement quantity which satisfies the required reliability degree will be described later.

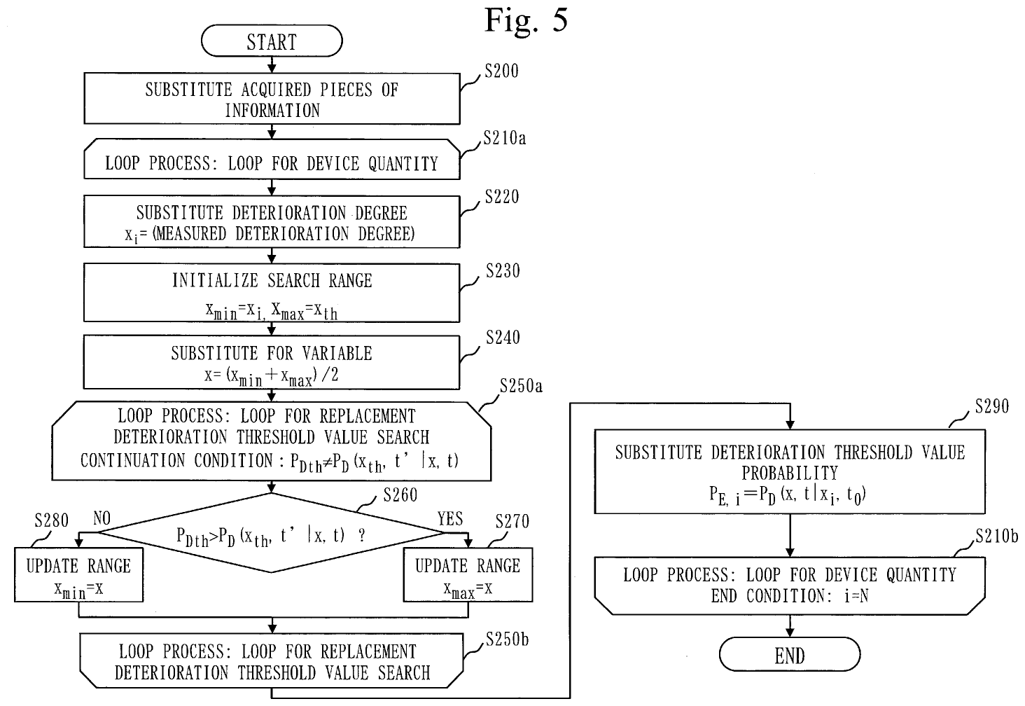

Next, with reference to a flowchart of FIG. 5, examples of the calculation processes of the replacement deterioration threshold values and the deterioration-threshold-value probabilities by the threshold-value calculation unit 111 and the probability calculation unit 112 of the management support apparatus 10 according to the first embodiment will be described respectively.

Note that, in the first embodiment, descriptions will be given, using an example in which the quantity of devices 20 is N and each device 20 uses one part.

Further, the descriptions will be given, using an example in which measurement of the deterioration degrees is performed on all of the N parts on the same date and further, a process of the management support apparatus 10 is performed on the same date as the measurement date. But, not limited to the above descriptions, the measurement date may be different depending on each of N devices 20, and the measurement date and a date to perform the process of the management support apparatus 10 may be different from each other.

First, in step S200, the threshold-value calculation unit 111 substitutes the pieces of information acquired by the information acquisition unit 100.

Specifically, the threshold-value calculation unit 111 substitutes the quantity of devices for N, the measurement date of the deterioration degrees for to, the next maintenance date for t, the maintenance date after the next for t′, the replacement-limit threshold value for Xₜₕ, and the criterion value for the upper probability for PDₜₕ.

Further, the threshold-value calculation unit 111 assigns to each of the N devices 20, each of numbers from 1 to N to be used for repeating a process, one by one without duplication.

Next, steps S210a to 210b constitutes a loop process in which the probability calculation unit 112 calculates the deterioration-threshold-value probability P_{E,i} (i:1 to N) of the part of each of the N devices 20.

First, in step S210a, the threshold-value calculation unit 111 substitutes 1 as an initial value for i. However, if the process returns from step S210b, the threshold-value calculation unit 111 does not substitute 1 as the initial value for i.

Next, in step S220, the threshold-value calculation unit 111 substitutes for xi, the measured deterioration degree of the device 20 assigned the number i.

Next, in step S230, the threshold-value calculation unit 111 initializes a search range which is for searching for the replacement deterioration threshold value. Specifically, the threshold-value calculation unit 111 initializes the search range, by setting a variable x for the deterioration degree to be used for search, substituting xᵢ for a minimum value xₘᵢₙ and substituting Xₜₕ for a maximum value xₘₐₓ, as the search range.

Next, in step S240, the threshold-value calculation unit 111 substitutes a value for the variable x. Specifically, the threshold-value calculation unit 111 substitutes (xₘᵢₙ+xₘₐₓ)/2 for the variable x.

Next, steps S250a to 250b constitutes a loop process in which the threshold-value calculation unit 111 changes the search range and searches for the replacement deterioration threshold value.

First, in step S250a, the threshold-value calculation unit 111 sets the deterioration degree on a next maintenance date t as a variable x, and derives the succeeding-deterioration-degree probability distribution which is the probability distribution of the deterioration degree on a maintenance date after the next t′.

More specifically, the threshold-value calculation unit 111 loads from the auxiliary storage device 13, a program which executes the deterioration prediction. The program which executes the deterioration prediction is at least a program which derives the probability distribution of the deterioration degree at a time point in the future, using a reference time point and the deterioration degree at the reference time point.

Note that, the program which executes the deterioration prediction may derive the probability distribution of the deterioration degree at the time point in the future, using information on the surrounding such as weather and temperature, or information such as usage frequencies of the parts.

Then, the threshold-value calculation unit 111 derives the succeeding-deterioration-degree probability distribution on the maintenance date after the next t′, using the deterioration degree x and the next maintenance date t.

Then, the threshold-value calculation unit 111 calculates P_{D}(x_{th,t}′|x,t) based on the succeeding-deterioration-degree probability distribution.

P_{D}(x_{th,t}′|x,t) indicates an upper probability that the deterioration degree on the maintenance date after the next t′ is equal to or larger than xₜₕ when the deterioration degree on the next maintenance date t is x.

Then, the threshold-value calculation unit 111 performs same-value determination to check whether or not a criterion value P_{Dth} for the upper probability and P_{D}(x_{th,t}′|x,t) are the same.

If it is confirmed that P_{Dth} and P_{D}(x_{th,t}′|x,t) are the same, x becomes the replacement deterioration threshold value. Then, the process proceeds to step S290.

On the other hand, if it is not confirmed that P_{Dth} and P_{D}(x_{th,t}′|x,t) are the same, the threshold-value calculation unit 111 updates the variable x. Specifically, the threshold-value calculation unit 111 updates the variable x by substituting (xₘᵢₙ+xₘₐₓ)/2 for x. Then, the process returns to step S250a. However, if the process is not a return from step S250b, the variable x is not updated.

Note that, since the processor 11 performs computation based on a floating point, there is a possibility that P_{Dth} and P_{D}(x_{th,t}′ |x,t) are not the same values. However, when P_{Dth} and P_{D}(x_{th,t}′ |x,t) are not the same values, the threshold-value calculation unit 111 may regard P_{Dth} and P_{D}(x_{th,t}′|x,t) as the same values if a difference between P_{Dth} and P_{D}(x_{th,t}′ |x,t) is little. As a specific example, the threshold-value calculation unit 111 determines the two values as the same if the difference between P_{Dth} and P_{D}(x_{th,t}′|x,t) is 1e-6.

Next, in step S260, the threshold-value calculation unit 111 checks whether or not P_{Dth} is larger than P_{D}(x_{th,t}′|x,t).

If it is confirmed that P_{Dth} is larger than P_{D}(xₜₕ,t′|x,t), the process proceeds to step S270.

On the other hand, if it is not confirmed that P_{Dth} is larger than P_{D}(x_{th,t}′ |x,t), the process proceeds to step S280.

Next, in step S270, the threshold-value calculation unit 111 updates the maximum value of the search range and narrows the search range. Specifically, the threshold-value calculation unit 111 substitutes x for xₘₐₓ.

Next, in step S280, the threshold-value calculation unit 111 updates the minimum value of the search range and narrows the search range. Specifically, the threshold-value calculation unit 111 substitutes x for xₘᵢₙ.

Next, in step S250b, the process returns to step S250a.

Next, in step S290, the probability calculation unit 112 derives the deterioration-degree probability distribution which is a probability distribution of the deterioration degree on the next maintenance date t, and calculates a deterioration threshold-value probability P_{E,i}.

More specifically, the probability calculation unit 112 loads from the auxiliary storage device 13, the program which executes the deterioration prediction.

Then, the probability calculation unit 112 derives the deterioration-degree probability distribution on the next maintenance date t, using the deterioration degree xᵢ and a measurement date to of the deterioration degree.

Then, the probability calculation unit 112 calculates P_{D}(x,t|xᵢ,t₀). P_{D}(x,t|xᵢ,t₀) indicates an upper probability that the deterioration degree on the next maintenance date t is equal to or larger than the replacement deterioration threshold value x when the deterioration degree on the measurement date to of the deterioration degree is xᵢ.

Then, the probability calculation unit 112 substitutes P_{D}(x,t|xᵢ,t₀) for the deterioration-threshold-value probability P_{E,i}.

Then, in step S210b, the probability calculation unit 112 checks whether or not i is N.

If it is confirmed that i is N, the process ends.

On the other hand, if it is not confirmed that i is N, the process returns to step S210a.

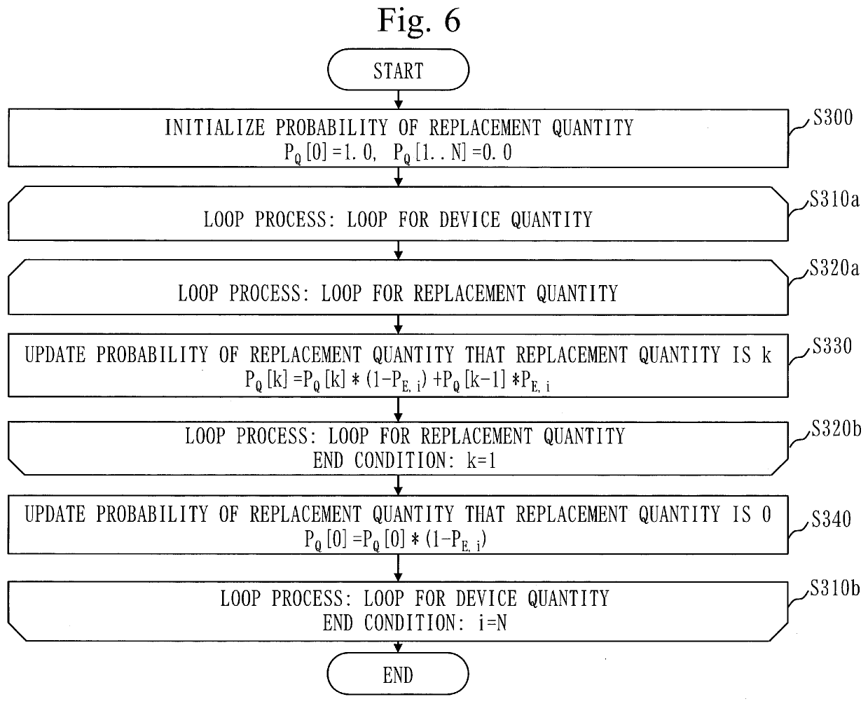

Next, with reference to a flowchart of FIG. 6, an example will be described of the derivation process of the probability distribution of the replacement quantity by the probability-distribution derivation unit 113 of the management support apparatus 10 according to the first embodiment.

First, in step S300, the probability-distribution derivation unit 113 initializes a probability P_{Q}[k](k:0 to N) of the replacement quantity. More specifically, the probability-distribution derivation unit 113 substitutes 1.0 for P_{Q}[0] and 0.0 for each of P_{Q}[1] to P_{Q}[N].

Next, steps S310a to S310b constitutes a loop process in which the probability-distribution derivation unit 113 processes a deterioration-threshold-value probability P_{E}[i] in order from i=1 to i=N and updates the probability P_{Q}[k](k:0 to N) of the replacement quantity.

First, in step S310a, the probability-distribution derivation unit 113 substitutes 1 for i, as an initial value. However, if the process returns from step S310b, the probability-distribution derivation unit 113 does not substitute 1 for i, as the initial value.

Next, steps S320a to S320b constitutes a loop process in which the probability-distribution derivation unit 113 sets the replacement quantity as k and updates the probability P_{Q}[k] of the replacement quantity in order from k=N to K=1. Note that, since an update process is different only in a case of k=0, k=0 is excluded from the loop process.

First, in step S320a, the probability-distribution derivation unit 113 substitutes N for the replacement quantity k, as an initial value. However, if the process returns from step S320b, the probability-distribution derivation unit 113 does not substitute N for the replacement quantity k, as the initial value.

Next, in step S330, the probability-distribution derivation unit 113 updates the probability P_{Q}[k] of the replacement quantity that the replacement quantity is k.

P_{Q}[k] is a sum of a probability in a case where the replacement quantity for devices up to an i−1-th device 20 is k and replacement is not performed on an i-th device 20 and a probability in a case where the replacement quantity for the devices up to the i−1-th device 20 is k−1 and replacement is performed on the i-th device 20. Therefore, the probability-distribution derivation unit 113 updates P_{Q}[k] by substituting P_{Q}[k]*(1−P_{E,i})+PQ[k−1]*P_{E,i} for P_{Q}[k].

Next, in step S320b, the probability-distribution derivation unit 113 checks whether or not the replacement quantity k is 1.

If it is confirmed that k is 1, the process proceeds to step S340.

On the other hand, if it is not confirmed that k is 1, the probability-distribution derivation unit 113 subtracts 1 from k. Then, the process returns to step S320a.

Next, in step S340, the probability-distribution derivation unit 113 updates a probability P_{Q}[0] of the replacement quantity that the replacement quantity is 0.

Specifically, P_{Q}[0] is a probability in a case where the replacement quantity for the devices up to the i−1-th device 20 is 0 and the replacement is not performed also on the i-th device 20. Therefore, the probability-distribution derivation unit 113 updates P_{Q}[0] by substituting P_{Q}[0]*(1−P_{E,i}) for P_{Q}[0].

Next, in step S310b, the probability-distribution derivation unit 113 checks whether or not i is N.

If it is confirmed that i is N, the process ends.

On the other hand, if it is not confirmed that i is N, the probability-distribution derivation unit 113 adds 1 to i. Then, the process returns to step S310a.

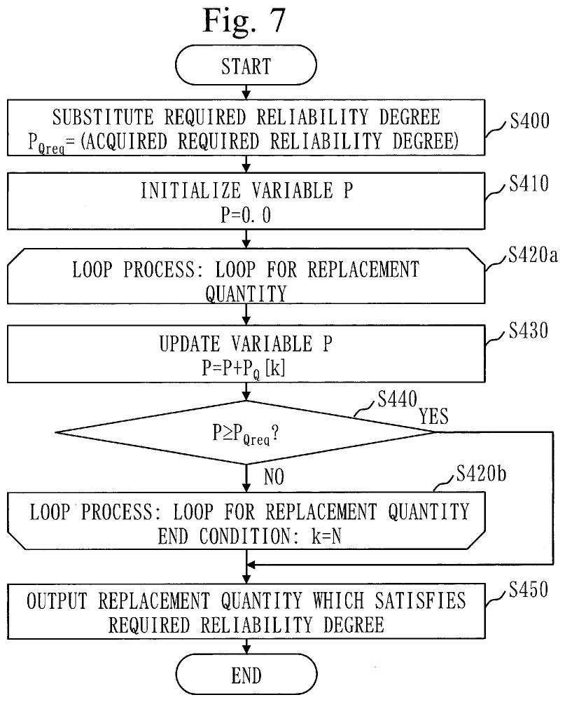

Next, with reference to FIG. 7, an example will be described of the calculation process of the replacement quantity which satisfies the required reliability degree, by the replacement-quantity calculation unit 114 of the management support apparatus 10 according to the first embodiment.

First, in step S400, the replacement-quantity calculation unit 114 substitutes the acquired required reliability degree for P_{Qreq}.

Next, in step S410, the replacement-quantity calculation unit 114 initializes a variable P by substituting 0.0 for the variable P used as a temporary cumulative value of the lower probability.

Next, steps S420a to S420b constitutes a loop process in which the replacement-quantity calculation unit 114 updates the variable P in order of the replacement quantity from k=0 to k=N.

First, in step S420a, the replacement-quantity calculation unit 114 substitutes 0 for the replacement quantity k, as an initial value. However, if the process returns from step S20b, the replacement-quantity calculation unit 114 does not substitute 0 for the replacement quantity k, as the initial value.

Next, in step S430, the replacement-quantity calculation unit 114 updates the variable P.

Specifically, the replacement-quantity calculation unit 114 updates the variable P by substituting P+P_{Q}[k] for P.

Next, in step S440, the replacement-quantity calculation unit 114 checks whether or not P is equal to or larger than a required reliability degree P_{Qreq}.

If it is confirmed that P is equal to or larger than the required reliability degree P_{Qreq}, the process proceeds to step S450.

On the other hand, if it is not confirmed that P is equal to or larger than the required reliability degree P_{Qreq}, the process proceeds to step S420b.

Next, in step S420b, the replacement-quantity calculation unit 114 adds 1 to k. Then, the process returns to step S420a.

Then, in step S450, the replacement-quantity calculation unit 114 outputs k as the replacement quantity which satisfies the required reliability degree P_{Qreq}.

### Description of Effect of Embodiment

As described above, in the first embodiment, the management support apparatus 10 calculates the replacement quantity which satisfies the required reliability degree, based on the measurement results. Therefore, the necessary minimum inventory quantity of replacing parts is properly estimated.

The replacing parts can be obtained readily if the replacing parts are commodities, however, in many cases, custom-made parts are used in systems of social infrastructures such as railway cars, a power plant, and an elevator. Then, lead time taken for preparing the inventory of the custom-made parts tends to be longer than that for the commodities, and it is very important to precisely estimate the necessary inventory quantity as early as possible.

When a deteriorated item is not replaced in time due to the inventory shortage of the replacing part, there is a possibility that a whole system stops and enormous damage is caused even when a malfunction occurs at the item being a portion of the system. Further, since the items used in the systems such as the social infrastructures are required to be high-performance and high-quality, the items tend to be expensive. Therefore, excess inventory of replacement-purpose items is a financially-large burden.

The necessary minimum inventory quantity of replacing parts are properly estimated by the management support apparatus 10, therefore, the manager of the inventory can reduce the financial burden resulted from the excess inventory, while preventing the damage resulted from the inventory shortage of the replacing parts.

Further, labor required for estimation based on personal experience of the manager of the inventory is reduced.

Note that, in the first embodiment, as examples of a replacement timing and a succeeding replacement timing, the next maintenance date and the maintenance date after the next are used respectively. But, not limited to these, the replacement timing and the succeeding replacement timing may be any maintenance date and any maintenance date after the maintenance date respectively.

Alternatively, not only the maintenance date, but also any form of unit of time such as maintenance time, a maintenance time range, a maintenance week, and a maintenance month may be applied to the replacement timing.

Further, in the first embodiment, the management support apparatus 10 outputs the replacement quantity as the process result of the necessary minimum inventory quantity of replacing parts, but not limited to this, the management support apparatus 10 may output the replacement deterioration threshold values, the deterioration-threshold-value probabilities, and the probability distribution of the replacement quantity.

### Second Embodiment

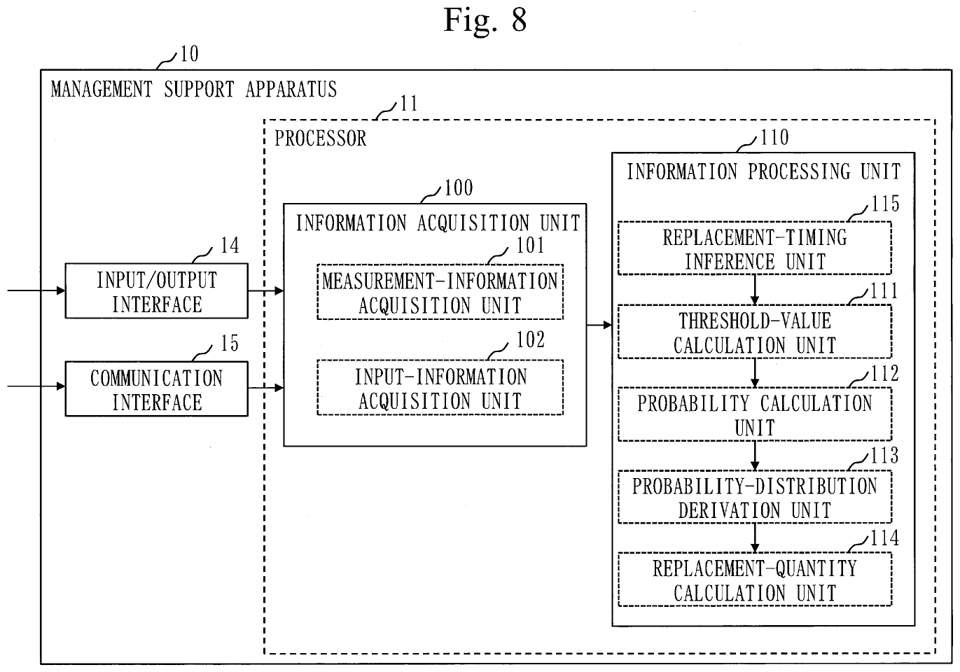

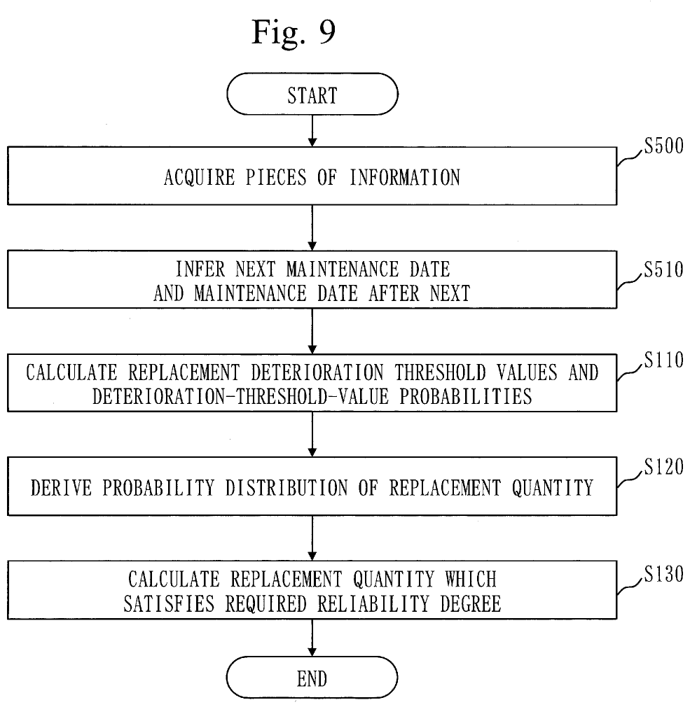

A second embodiment will be described with reference to FIGS. 8 and 9. In the second embodiment, an example will be described of calculating the necessary minimum inventory quantity of replacing parts. The example is premised that delivery dates when shipped replacing parts are delivered to the usage environment come irregularly, consequently, the next maintenance date and the maintenance date after the next when the parts are replaced come irregularly.

A specific example is an example in which a fixed date is not set for adding the replacing parts due to a matter of transportation such as a truck, a railway, and an airplane, consequently, the maintenance date comes irregularly.

In the second embodiment, mainly matters different from the first embodiment will be described.

Note that, matters not described below are the same as those in the first embodiment.

FIG. 8 illustrates a functional configuration example of the management support apparatus 10 according to the second embodiment.

Note that, the same components as those in the first embodiment are assigned the same numerals, and descriptions thereof will be omitted.

In the second embodiment, the input-information acquisition unit 102 newly acquires a delivery plan describing delivery dates via the input/output interface 14 or the communication interface 15.

Further, in the second embodiment, the management support apparatus 10 newly includes a replacement-timing inference unit 115.

The replacement-timing inference unit 115 checks the delivery dates described in the delivery plan and infers a candidate date for the next maintenance date and a candidate date for the maintenance date after the next.

FIG. 9 is a flowchart illustrating an operation example of the management support apparatus 10 according to the second embodiment.

Note that, the same operations as those in the first embodiment are assigned the same numerals, and descriptions thereof will be omitted.

In step S500, the measurement-information acquisition unit 101 acquires the measured deterioration degrees and the measurement date of the deterioration degrees as the pieces of measurement information regarding the deterioration degrees of the parts of the devices 20. Further, the input-information acquisition unit 102 acquires the replacement-limit threshold values, the criterion values for the upper probabilities, and the required reliability degree as the pieces of input information regarding the calculation of the replacement quantity.

Further, the input-information acquisition unit 102 acquires the delivery plan describing the delivery dates.

Next, in step S510, the replacement-timing inference unit 115 infers the next maintenance date and the maintenance date after the next based on the delivery dates.

Specifically, the replacement-timing inference unit 115 checks a next delivery date and a delivery date after the next which are described in the delivery plan. Then, the replacement-timing inference unit 115 infers a day after the next delivery date as the next maintenance date. Further, the replacement-timing inference unit 115 infers a day after the delivery date after the next as the maintenance date after the next.

Note that, the maintenance date is not limited to the day after the delivery date, the number of days between the delivery date and the maintenance date may be input via the input/output interface 14, and the replacement-timing inference unit 115 may infer the next maintenance date and the maintenance date after the next, using the input number of days.

Further, the replacement-timing inference unit 115 may infer a plurality of next maintenance dates and a plurality of maintenance dates after the next.

Since steps S110 to S130 are the same as those described in the first embodiment, descriptions thereof will be omitted.

Note that, if a plurality of maintenance dates are inferred for at least one of the next maintenance date and the maintenance date after the next, there are a plurality of combinations of the candidate for the next maintenance date and the candidate for the maintenance date after the next. If there are the plurality of combinations of the candidate for the next maintenance date and the candidate for the maintenance date after the next as described above, the processes of steps S110 to S130 may be performed for each combination.

As descried above, in the second embodiment, the management support apparatus 10 properly estimates the necessary minimum inventory quantity of replacing parts also when the delivery dates come irregularly, consequently, the next maintenance date and the maintenance date after the next come irregularly. As a result, it is possible to prevent the inventory shortage and the excess inventory.

Further, when the delivery dates come irregularly, consequently, the next maintenance date and the maintenance date after the next come irregularly, the labor required for the estimation based on the personal experience of the manager of the inventory is equal to or more than that in the first embodiment. Therefore, in the second embodiment, an effect of more reduction in the labor is expected.

### Third Embodiment

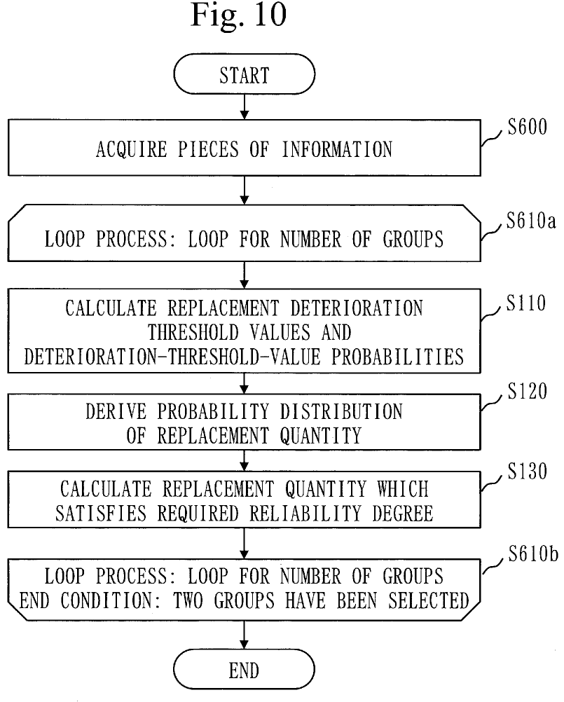

A third embodiment will be described with reference to FIG. 10.

In the third embodiment, an example will be described of calculating the necessary minimum inventory quantity of replacing parts in a case where the maintenance date when the part is replaced is different depending on each device.

A specific example is an example in which a different inspection date is set for each device in which a part is placed, depending on each device, like parts placed in a composition of train cars, accordingly, the maintenance date of each is different.

In the third embodiment, mainly matters different from the first embodiment will be described.

Note that, matters not described below are the same as those in the first embodiment.

FIG. 10 is a flowchart illustrating an operation example of the management support apparatus 10 according to the third embodiment.

Note that, in the third embodiment, descriptions will be given, using an example in which the quantity of devices 20 is 2N and there are two classified groups into each of which N devices 20 are classified. Then, the descriptions will be given, using an example in which the next maintenance date and the maintenance date after the next are different depending on each group.

Note that, the number of groups is not limited to two, and the number of groups may be equal to or more than two. Further, the quantity of devices 20 classified into each group is not limited to N, and as a result of classification based on the next maintenance date and the maintenance date after the next, each group may have a different quantity of devices 20.

Note that, the same operations as those in the first embodiment are assigned the same numerals, and descriptions thereof will be omitted.

In step S600, the measurement-information acquisition unit 101 acquires the measured deterioration degrees and the measurement date of the deterioration degrees as the pieces of measurement information regarding the deterioration degrees of the parts of the devices 20.

Further, the input-information acquisition unit 102 acquires the replacement-limit threshold values, the criterion values for the upper probabilities, and the required reliability degree as the pieces of input information regarding the calculation of the replacement quantity.

Further, the input-information acquisition unit 102 acquires for each device, the next maintenance date and the maintenance date after the next. Then, the input-information acquisition unit 102 classifies the devices 20 into two groups each of which is to have the N devices 20 which have the same next maintenance date and the same maintenance date after the next.

Next, steps S610a to S610b constitutes a loop process of calculating the replacement quantity for each of the two groups.

First, in step S610a, the threshold-value calculation unit 111 selects one of the two groups. Then, the threshold-value calculation unit 111 performs the calculation processes of the replacement deterioration threshold values of the parts of the devices 20 in the selected group.

Since steps S110 to S130 are the same as those described in the first embodiment and the second embodiment, descriptions thereof will be omitted.

Then, in step S610b, the replacement-quantity calculation unit 114 checks whether or not both of the two groups have been selected.

If it is confirmed that both of the two groups have been selected, the process ends.

If it is not confirmed that both of the two groups have been selected, the process returns to step S610a.

As described above, in the third embodiment, the management support apparatus 10 properly estimates the necessary minimum inventory quantity of replacing parts also when the next maintenance date and the maintenance date after the next are different depending on each device. As a result, it is possible to prevent the inventory shortage and the excess inventory.

Further, when the next maintenance date and the maintenance date after the next are different depending on each device, labor required for the estimation based on the personal experience of the manager of the inventory is equal to or more than that in the first embodiment. Therefore, in the third embodiment, an effect of more reduction in the labor is expected.

### Fourth Embodiment

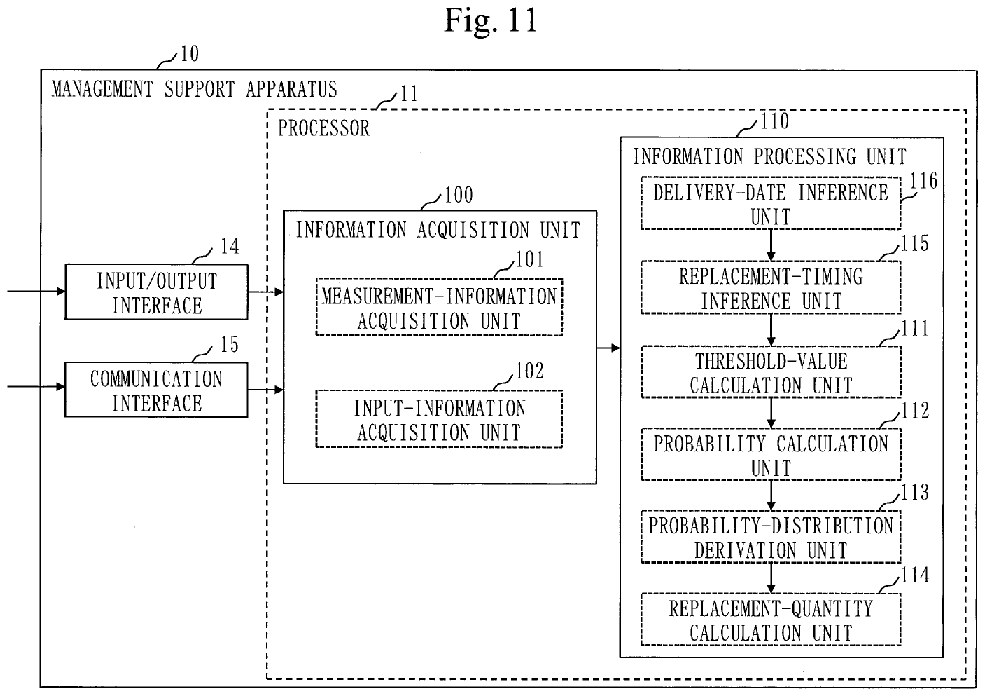

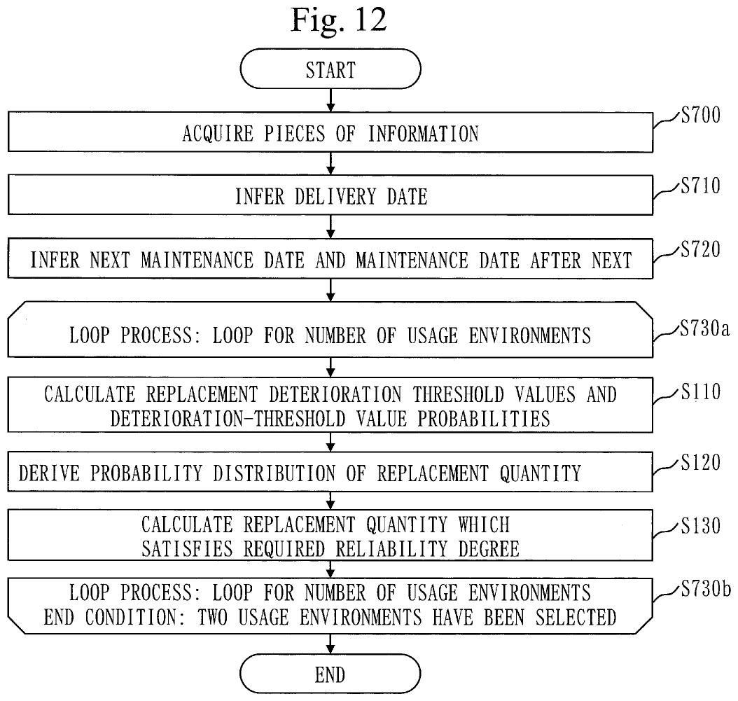

With reference to FIGS. 11 and 12, a fourth embodiment will be described. In the fourth embodiment, an example will be described of calculating the necessary minimum inventory quantity of replacing parts. The example is premised that each of a location of the usage environment and an inventory storage place of the replacing part for the part used by the device is different depending on each part and the maintenance date is different depending on each usage environment.

A specific example is an example in which there are a plurality of usage environments which are geographically far from each other and a location of the inventory storage place and each of the usage environments are geographically far from each other, like elevators.

In the fourth embodiment, mainly matters different from the second embodiment will be described.

Note that, matters not described below are the same as those in the second embodiment.

FIG. 11 illustrates a functional configuration example of the management support apparatus 10 according to the fourth embodiment.

Note that, the same components as those in the second embodiment are assigned the same numerals, and descriptions thereof will be omitted.

In the fourth embodiment, the management support apparatus 10 newly includes a delivery-date inference unit 116.

The delivery-date inference unit 116 infers a delivery date based on at least one of pieces of information regarding inference of the delivery date, such as the location of the usage environment, a distance from the usage environment to delivery origin of the replacing part, and the number of days required for delivering the replacing part.

Further, in the fourth embodiment, the input-information acquisition unit 102 newly acquires the pieces of information regarding the inference of the delivery date via the input/output interface 14 or the communication interface 15.

FIG. 12 is a flowchart illustrating an operation example of the management support apparatus 10 according to the fourth embodiment.

Note that, in the fourth embodiment, descriptions will be given, using an example in which the quantity of devices 20 is 2N and N devices 20 are used in each of two usage environments whose locations are different from each other.

Then, an example will be used in which the next maintenance date and the maintenance date after the next for the parts used by the devices 20 are different depending on each of the two usage environments.

Note that, the number of usage environments is not limited to two and may be equal to or more than two. Further, the quantity of devices 20 used in each usage environment is not limited to N, and each of usage environments may have a different quantity of devices 20 from each other.

Note that, the same operations as those in the second embodiment are assigned the same numerals, and descriptions thereof will be omitted.

In step S700, the measurement-information acquisition unit 101 acquires the measured deterioration degrees and the measurement date of the deterioration degrees as the pieces of measurement information regarding the deterioration degrees of the parts of the devices 20.

Further, the input-information acquisition unit 102 acquires the replacement-limit threshold values, the criterion values for the upper probabilities, and the required reliability degree as the pieces of input information regarding the calculation of the replacement quantity.

Further, the input-information acquisition unit 102 acquires the pieces of information regarding the inference of the delivery dates.

In step S710, the delivery-date inference unit 116 infers the delivery date when the replacing part is delivered to each usage environment, based on the acquired pieces of information regarding the inference of the delivery date.

Specifically, if the number of days required for delivering the replacing part is used for the inference of the delivery date, the delivery-date inference unit 116 infers the delivery date based on the number of days required for delivering the replacing part.

Further, if the location of the usage environment of the part is used for the inference of the delivery date, the delivery-date inference unit 116 infers the delivery date, by reading from the auxiliary storage device 13, a comparison table between the locations of the usage environments of the parts and the respective numbers of days required for delivering the replacing part.

Further, if distance from the location of the usage environment of the part to the delivery origin is used for the inference of the delivery date, the delivery-date inference unit 116 infers the delivery date, by reading from the auxiliary storage device 13, a comparison table between the distances from the locations of the usage environments of the parts to the respective delivery origins, and the respective numbers of days required for delivering the replacing part.

Next, in step S720, the replacement-timing inference unit 115 infers the next maintenance date and the maintenance date after the next for each usage environment based on the delivery date inferred for each usage environment.

Specifically, the replacement-timing inference unit 115 infers for each usage environment, a day after the next delivery date as the next maintenance date and a day after the delivery date after the next as the maintenance date after the next.

Note that, the maintenance date is not limited to the day after the delivery date, the number of days from the delivery date to the maintenance date may be input via the input/output interface 14, and the replacement-timing inference unit 115 may infer the next maintenance date and the maintenance date after the next.

Further, the replacement-timing inference unit 115 may infer for each usage environment, a plurality of next maintenance dates and a plurality of maintenance dates after the next.

Next, steps S730a to S730b constitutes a loop process of calculating for each of the two usage environments, the replacement quantity on each corresponding maintenance date.

First, in step S730a, the threshold-value calculation unit 111 selects one of the two usage environments. Then, the threshold-value calculation unit 111 performs the calculation processes of the replacement deterioration threshold values of the parts of the devices 20 in the selected usage environment.

Since steps S110 to S130 are the same as those described in the first embodiment and the second embodiment, descriptions thereof will be omitted.

Note that, if a plurality of maintenance dates are inferred for at least one of the next maintenance date and the maintenance date after the next, there are a plurality of combinations of the candidate for the next maintenance date and the candidate for the maintenance date after the next. If there are the plurality of combinations of the candidate for the next maintenance date and the candidate for the maintenance date after the next as described above, the processes of steps S110 to S130 may be performed for each combination.

Then, in step S730b, the replacement-quantity calculation unit 114 checks whether or not both of the two usage environments have been selected.

If it is confirmed that both of the two groups have been selected, the process ends.

If it is not confirmed that both of the two groups have been selected, the process returns to step S730a.

As described above, in the fourth embodiment, the management support apparatus 10 properly estimates the necessary minimum inventory quantity of replacing parts also when the location of the usage environment and the inventory storage place of the replacing part are different depending on each part and the maintenance date is different depending on each usage environment. As a result, it is possible to prevent the inventory shortage and the excess inventory.

### Fifth Embodiment

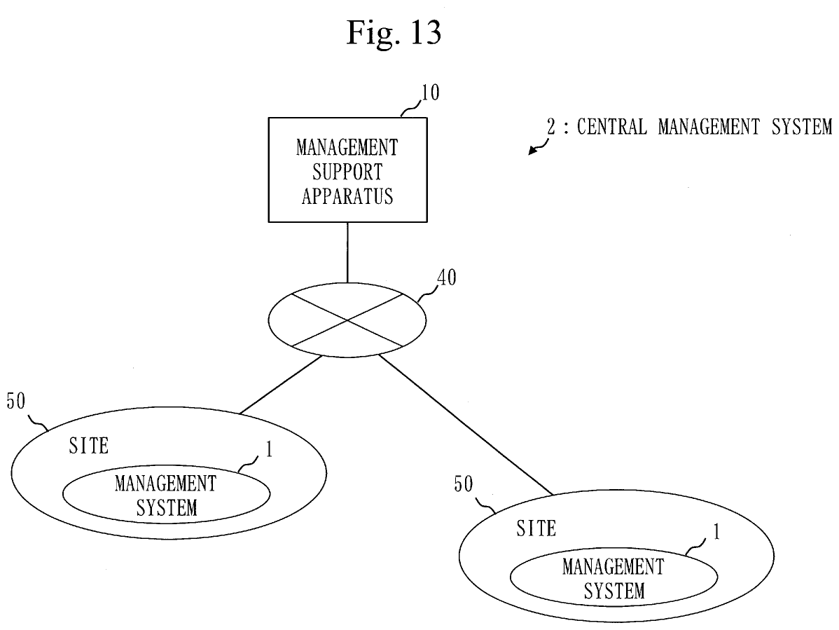

A fifth embodiment will be described with reference to FIGS. 13 to 16. In the fifth embodiment, an example will be used in which the usage environment where the parts are used is constituted by a plurality of usage places and the probability distribution of the replacement quantity for the usage place is derived for each of the plurality of usage places. Then, an example will be described of calculating the necessary minimum inventory quantity of replacing parts, using the derived probability distribution of the replacement quantity for each of the plurality of usage places. The example is premised that the inventory quantities of replacing parts in the usage environment are centrally managed.

A specific example is an example in which each of a plurality of factories manages its inventory quantity of replacing parts and one central management warehouse manages the replacing parts to be delivered to each of the factories, like a production device in a factory.

In fifth embodiment, mainly matters different from the first embodiment will be described.

Note that, matters not described below are the same as those in the first embodiment

FIG. 13 is a configuration diagram of a central management system 2 according to the fifth embodiment.

Note that, descriptions will be given, using sites such as factories as examples of the usage places. Then, descriptions will be given, assuming that the usage environment is constituted by the plurality of usage places.

The central management system 2 includes the management support apparatus 10, the network 40, and sites 50.

The site 50 is the usage place where the parts of the plurality of devices 20 are used. As a specific example, the site 50 is a place such as a factory or a power plant.

In the sites 50, the management systems 1 in the first embodiment are placed. Further, the management support apparatuses 10 in the management systems 1 in the sites 50 and the management support apparatus 10 in the central management system 2 are connected to each other via the network 40.

Note that, in FIG. 13, the number of sites 50 is two, but not limited to two, the number of sites 50 may be equal to or more than two.

Since the management support apparatuses 10 and the network 40 are the same as those described in the first embodiment, descriptions thereof will be omitted.

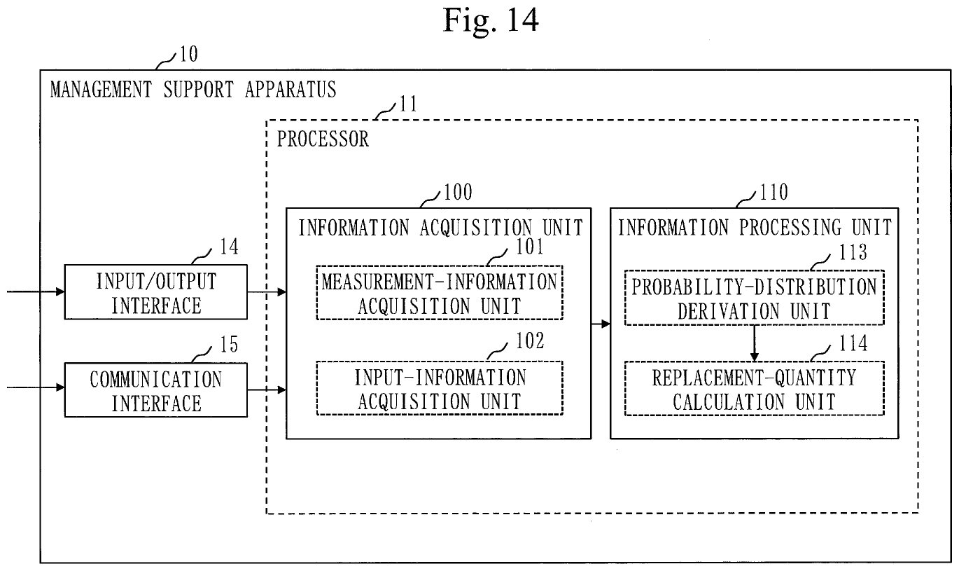

FIG. 14 illustrates a functional configuration example of the management support apparatus 10 according to the fifth embodiment.

Note that, the same components as those in the first embodiment are assigned the same numerals, and descriptions thereof will be omitted.

In the fifth embodiment, the measurement-information acquisition unit 101 acquires as the measurement results, the probability distributions of the replacement quantities for the sites 50 from the management support apparatuses 10 in the sites 50 via the communication interface 15.

Further, in the fifth embodiment, the probability-distribution derivation unit 113 derives the probability distribution of the replacement quantity for the usage environment, using the probability distributions of the replacement quantities for the sites 50 which have been acquired by the measurement-information acquisition unit 101.

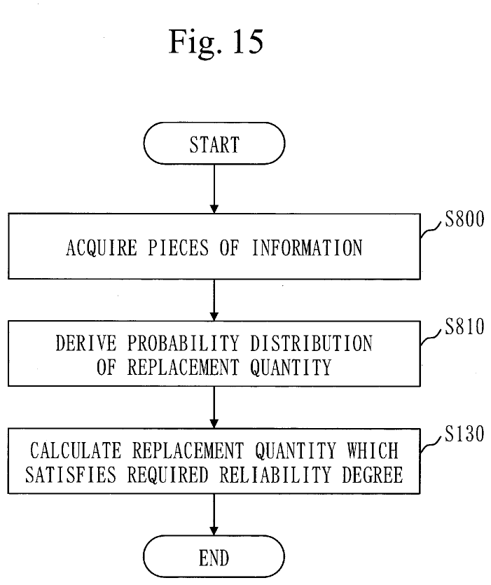

FIG. 15 is a flowchart illustrating an operation example of the management support apparatus 10 according to the fifth embodiment.

Note that, in the fifth embodiment, descriptions will be given, using an example in which the quantity of devices 20 is 2N and N devices 20 are used in each of two sites 50 whose locations are different from each other.

Note that, the same operation as that in the first embodiment is assigned the same numeral, and descriptions thereof will be omitted.

In step S800, the measurement-information acquisition unit 101 acquires the probability distributions of the replacement quantities for the sites 50, as the pieces of measurement information.

Further, the input-information acquisition unit 102 acquires the replacement-limit threshold values, the criterion values for the upper probabilities, and the required reliability degrees, as the pieces of input information regarding the calculation of the replacement quantities.

Next, in step S810, the probability-distribution derivation unit 113 derives the probability distribution of the replacement quantity for the usage environment, using the probability distributions of the replacement quantities for the sites 50 which have been acquired by the measurement-information acquisition unit 101. Details of the derivation process of the probability distribution of the replacement quantity according to the fifth embodiment will be described later.

Since step S130 is the same as that described in the first embodiment, descriptions thereof will be omitted.

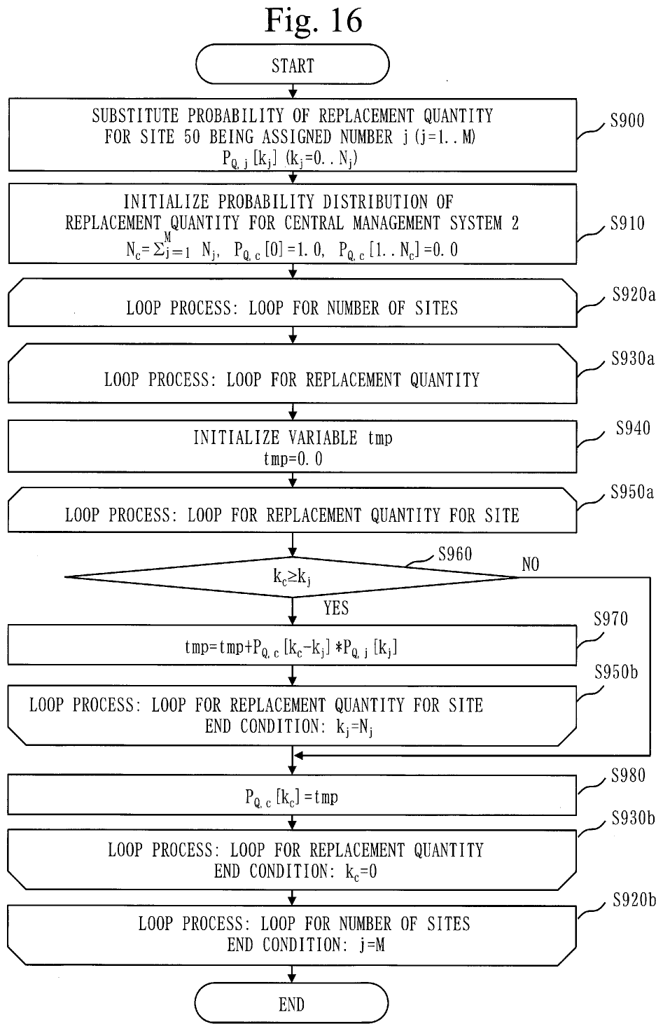

FIG. 16 is a flowchart illustrating an example of the derivation process of the probability distribution of the replacement quantity for the usage environment by the probability-distribution derivation unit 113 of the management support apparatus 10 according to the fifth embodiment.

Note that, in the fifth embodiment, descriptions will be given, assuming that all of the maintenance dates for the sites 50 are the same date or the same time.

Further, the descriptions will be given, assuming that there are M sites 50.

In step S900, the probability-distribution derivation unit 113 substitutes the probability of the replacement quantity, from the probability distribution of the replacement quantity for the site 50.

More specifically, the probability-distribution derivation unit 113 assigns to each of the M sites 50, each of numbers from 1 to M to be used for repeating a process, one by one without duplication.

Further, the probability-distribution derivation unit 113 checks a range of the replacement quantity from the probability distribution of the replacement quantity for the site 50 being assigned a number j (j:1 to M), and substitutes a maximum value for

Further, the probability-distribution derivation unit 113 substitutes for P_{Q,j}[k_{J}], a probability that the replacement quantity is kₐ(kₐ: 0 to Nₐ).

Next, in step S910, the probability-distribution derivation unit 113 initializes the probability distribution of the replacement quantity for the usage environment.

Specifically, the probability-distribution derivation unit 113 calculates a maximum value N_{c} of the replacement quantity for the usage environment, using a formula 1.

$${N}_{c} = {\sum }_{j = 1}^{M} {N}_{j} \qquad [ formula 1 ]$$

Then, the probability-distribution derivation unit 113 substitutes 1.0 for a probability P_{Q,c}[0] that the replacement quantity is 0, as the probability of the replacement quantity for the usage environment, to initialize the probability P_{Q},c[0]. Further, the probability-distribution derivation unit 113 substitutes 0.0 for a probability P_{Q,c}[k_{c}] that the replacement quantity is kc (kc: 1 to Ne), to initialize the probability P_{Q,c}[k_{c}],

Next, steps S920a to S920b constitutes a loop process in which the probability-distribution derivation unit 113 processes the probability of the replacement quantity for each of the M sites 50 in order from the site 50 being j=1 to the site 50 being j=M.

First, in step S920a, the probability-distribution derivation unit 113 substitutes 1 for j, as an initial value. However, if the process returns from step S920b, the probability-distribution derivation unit 113 does not substitutes 1 for j, as the initial value.

Next, steps S930a to S930b constitutes a loop process in which the probability-distribution derivation unit 113 processes the probability of the replacement quantity for the usage environment in order from k_{c}=N_{c} to k_{c}=0, where k_{c} is the replacement quantity of parts.

First, in step S930a, the probability-distribution derivation unit 113 substitutes N_{c} for k_{c}, as an initial value. However, if the process returns from step S930b, the probability-distribution derivation unit 113 does not substitutes N_{c} for k_{c}, as the initial value.

Next, in step S940, the probability-distribution derivation unit 113 substitutes 0.0 for a variable tmp which is used as a temporary cumulative value of the probability of the replacement quantity, to initialize the variable tmp.

Next, steps S950a to S950b constitutes a loop process in which the probability-distribution derivation unit 113 updates the variable tmp in order from kⱼ=0 to kⱼ=Nⱼ, where kⱼ is the replacement quantity for the site 50 being assigned the number j.

First, in step S950a, the probability-distribution derivation unit 113 substitutes 0 for kⱼ, as an initial value. However, if the process returns from step S950b, the probability-distribution derivation unit 113 does not substitute 0 for kⱼ, as the initial value.

Next, in step S960, the probability-distribution derivation unit 113 checks whether or not the replacement quantity L for the usage environment is equal to or larger than the replacement quantity is, for the site 50 being assigned the number j.

If it is confirmed that L is equal to or larger than kⱼ, the process proceeds to step S970.

On the other hand, if it is not confirmed that L is equal to or larger than kⱼ, the process proceeds to step S980.

Next, in step S970, the probability-distribution derivation unit 113 updates the variable tmp.

Specifically, the probability-distribution derivation unit 113 updates the variable tmp, by substituting tmp+P_{Q,c}[k_{c}−kⱼ]*P_{Q,j}[kⱼ] for tmp.

Next, in step S950b, the probability-distribution derivation unit 113 adds 1 to kⱼ. Then, the process returns to S950a.

Next, in step S980, the probability-distribution derivation unit 113 substitutes the variable tmp for the probability P_{Q,c}[k_{c}] of the replacement quantity L.

Next, in step S930b, the probability-distribution derivation unit 113 checks whether or not L is 0.

If it is confirmed that L is 0, the process proceeds to step S920b.

On the other hand, if it is not confirmed that L is 0, the probability-distribution derivation unit 113 subtracts 1 from L. Then, the process returns to step S930a.

Next, in step S920b, the probability-distribution derivation unit 113 checks whether or not j is M.

If it is confirmed that j is M, the process ends. Then, the probability-distribution derivation unit 113 notifies the replacement-quantity calculation unit 114 of the derived probability distribution of the replacement quantity for the usage environment.

On the other hand, if it is not confirmed that j is M, the probability-distribution derivation unit 113 adds 1 to j. Then, process returns to step S920a.

As described above, in the fifth embodiment, the usage environment where the parts are used is constituted by the plurality of sites 50, and the probability distribution of the replacement quantity for the site 50 is derived for each of the plurality of sites 50. Then, the management support apparatus 10 properly estimates the necessary minimum inventory quantity of replacing parts, using the derived probability distributions of the replacement quantities for the sites 50, also when the inventory quantities of replacing parts in the usage environment are centrally managed. As a result, it is possible to prevent the inventory shortage and the excess inventory.

Further, the fifth embodiment can be applied to not only a case where a single company manages the inventory quantities in a central warehouse and subordinate warehouses, but also a case of business in a medicine selling method in Toyama. More specifically, the manufacturer can contract a client for a service-level agreement including the required reliability degree, and the manufacturer can manage its own warehouse of factories and a warehouse of the client based on the required reliability degree.

Although the embodiments have been described above, two or more of these embodiments may be combined and implemented.

Alternatively, one of these embodiments may be partially implemented.

Alternatively, two or more of these embodiments may be partially combined and implemented.

Note that, the present disclosure is not limited to these embodiments, and various modifications can be made as necessary.

***Supplement to Hardware Configuration***

In the management support apparatus 10 of FIG. 2, although the functions of the management support apparatus 10 are realized by software, the functions of the management support apparatus 10 may be realized by hardware.

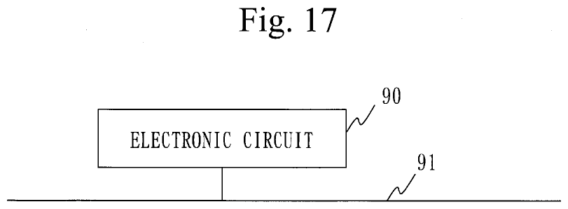

FIG. 17 illustrates a configuration in which the functions of the management support apparatus 10 are realized by the hardware.

An electronic circuit 90 in FIG. 17 is a dedicated electronic circuit for realizing the functions of the information acquisition unit 100 and the information processing unit 110 in the management support apparatus 10.

The electronic circuit 90 is connected to a signal line 91. Specifically, the electronic circuit 90 is a single circuit, a composite circuit, a programmed processor, a parallel-programmed processor, a logic IC, a GA, an ASIC, or an FPGA. GA stands for Gate Array. ASIC stands for Application Specific Integrated Circuit. FPGA stands for Field-Programmable Gate Array. Functions of components of the management support apparatus 10 may be realized by one electronic circuit or realized by being distributed among a plurality of electronic circuits. Further, a portion of the functions of the components of the management support apparatus 10 may be realized by the electronic circuit, and the rest of the functions may be realized by the software.

Each of the processor 11 and the electronic circuit 90 is also referred to as processing circuitry. In the management support apparatus 10, the functions of the information acquisition unit 100 and the information processing unit 110 may be realized by the processing circuitry.

### REFERENCE SIGNS LIST

1: management system, 2: central management system, 10: management support apparatus, 11: processor, 12: memory, 13: auxiliary storage device, 14: input/output interface, 15: communication interface, 20: device, 30: sensor, 40: network, 50: site, 100: information acquisition unit, 101: measurement-information acquisition unit, 102: input-information acquisition unit, 110: information processing unit, 111: threshold-value calculation unit, 112: probability calculation unit, 113: probability-distribution derivation unit, 114: replacement-quantity calculation unit, 115: replacement-timing inference unit, 116: delivery-date inference unit.

1. A management support apparatus comprising:
processing circuitry
to derive based on a measurement result obtained by measuring a deterioration degree resulted from usage of an item in a usage environment which uses the item which deteriorates with the usage, a probability distribution of a replacement quantity which is a quantity of the item required to be replaced at a replacement timing of the item; and
to calculate a replacement quantity with which a lower probability of the probability distribution of the replacement quantity is equal to or larger than a criterion value.

2. The management support apparatus according to claim 1, wherein
the usage environment uses one or more items, and
the processing circuitry derives the probability distribution of the replacement quantity, using as the measurement result of the deterioration degree, a deterioration-threshold-value probability which is a probability that the deterioration degree of each of the items at the replacement timing is equal to or larger than a replacement deterioration threshold value which is a replacement determination criterion at the replacement timing.

3. The management support apparatus according to claim 2, wherein
the processing circuitry calculates the deterioration-threshold-value probability based on a deterioration-degree probability distribution which is a probability distribution of the deterioration degree of each of the items at the replacement timing.

4. The management support apparatus according to claim 3, wherein
the processing circuitry derives the deterioration-degree probability distribution, using the measured deterioration degree of each of the items, and calculates the deterioration-threshold-value probability based on the derived deterioration-degree probability distribution.

5. The management support apparatus according to claim 2, wherein
the processing circuitry calculates the replacement deterioration threshold value based on a succeeding-deterioration-degree probability distribution which is a probability distribution of the deterioration degree of each of the items at another replacement timing coming after the replacement timing.

6. The management support apparatus according to claim 5, wherein
the processing circuitry derives the succeeding-deterioration-degree probability distribution, using the deterioration degree of each of the items at the replacement timing, and calculates the replacement deterioration threshold value based on the derived succeeding-deterioration-degree probability distribution.

7. The management support apparatus according to claim 1, wherein
the processing circuitry
infers the replacement timing based on a delivery date of a replacing item which replaces the item, and
derives the probability distribution of the replacement quantity at the inferred replacement timing.

8. The management support apparatus according to claim 7, wherein
the processing circuitry
infers the delivery date of the replacing item based on at least one of a location of the usage environment, a distance from the usage environment to a delivery origin of the replacing item, and the number of days required for delivering the replacing item, and
infers the replacement timing based on the inferred delivery date of the replacing item.

9. The management support apparatus according to claim 1, wherein
the usage environment is constituted by a plurality of usage places, and each of the plurality of usage places uses one or more items, and
the processing circuitry derives the probability distribution of the replacement quantity for the usage environment, using as the measurement result of the deterioration degree, the probability distribution of the replacement quantity for each of the plurality of usage places.

10. A management support method comprising:
deriving based on a measurement result obtained by measuring a deterioration degree resulted from usage of an item in a usage environment which uses the item which deteriorates with the usage, a probability distribution of a replacement quantity which is a quantity of the item required to be replaced at a replacement timing of the item; and
calculating a replacement quantity with which a lower probability of the probability distribution of the replacement quantity is equal to or larger than a criterion value.

11. A non-transitory computer readable medium storing a management support program which causes a computer to execute:
a probability-distribution derivation process of deriving based on a measurement result obtained by measuring a deterioration degree resulted from usage of an item in a usage environment which uses the item which deteriorates with the usage, a probability distribution of a replacement quantity which is a quantity of the item required to be replaced at a replacement timing of the item; and
a replacement-quantity calculation process of calculating a replacement quantity with which a lower probability of the probability distribution of the replacement quantity is equal to or larger than a criterion value.
